(19) United States
(12) Patent Application Publication
(10) Pub. No.: US 2025/0218425 A1
(43) Pub. Date: Jul. 3, 2025

(54) PROSODY PREDICTION METHOD, APPARATUS, READABLE MEDIUM, AND ELECTRONIC DEVICE

(71) Applicant: Beijing Youzhuju Network Technology Co., Ltd., Beijing (CN)

(72) Inventors: Yuxiang Zou, Beijing (CN); Zejun Ma, Beijing (CN)

(21) Appl. No.: 18/849,474

(22) PCT Filed: Mar. 17, 2023
(86) PCT No.: PCT/CN2023/082354

§ 371 Date: Sep. 21, 2024

(30) Foreign Application Priority Data
Mar. 21, 2022 (CN) 202210283933.0

(51) Int. Cl. G10L 13/10; G10L 13/027

(52) U.S. Cl. CPC G10L 13/10; G10L 13/027

(57) ABSTRACT

Here provide a method for prosody prediction, an apparatus, a readable medium, and an electronic device. The method includes: obtaining a target text to be processed; and determining prosody feature information of the target text based on the target text and a pre-trained prosody prediction model, the prosody feature information comprising prosody features corresponding to a plurality of predetermined prosody dimensions; wherein the prosody prediction model comprises a feature extraction network and a plurality of feature prediction networks, the feature extraction network being configured to extract linguistic information of the target text, the plurality of feature prediction networks each connected to the feature extraction network and being corresponding to the predetermined prosody dimensions, respectively, and each of the feature prediction networks being configured to predict, based on the linguistic information extracted by the feature extraction network, a prosody feature corresponding to a predetermined prosody dimension.

This disclosure claims priority to Chinese Patent Application No. 202210283933.0, filed with the Chinese Patent Office on Mar. 21, 2022, and entitled “PROSODY PREDICTION METHOD, APPARATUS, READABLE MEDIUM, AND ELECTRONIC DEVICE”, which is incorporated herein by reference in its entirety.

### FIELD

The present disclosure relates to the technical field of speech synthesis, and in particular, to a method for prosody prediction, an apparatus, a readable medium and an electronic device.

### BACKGROUND

In linguistics, prosody refers to a composition of a non-independent phonetic segments (a vowel or a consonant) during speech, i.e., a syllable or a property of a larger phonetic unit. These properties form language functions such as intonation, tone, emphasis, and rhythm. A prosody can characterize e a plurality of features of a speaker or an utterance: an emotion of the speaker, a form of the utterance (state, question, or command), whether having emphasis, contrast or focus, and other language elements that cannot be represented by grammar and vocabulary. Different representation forms of the same prosody event can convey rich semantics and emotional changes thereof. In tasks such as speech synthesis, adding different prosody features to a model helps making the generated audio more natural, has a guillous sense when hearing, and is more consistent with the semantics expressed by a speaker. Therefore, the prosody prediction (or modeling) for text is of great significance for speech synthesis, and the improvement of the accuracy of the prosody prediction has an important effect on the improvement of the naturalness of speech synthesis.

### SUMMARY

This section is provided to introduce concepts in a simplified form that are subsequently described in detail in the Detailed Description. This Summary is not intended to identify key features or essential features of the claimed subject matter, nor is it intended to be used to limit the scope of the claimed subject matter.

In a first aspect, the present disclosure provides a method for prosody prediction. The method comprises:
obtaining a target text to be processed; and
determining prosody feature information of the target text based on the target text and a pre-trained prosody prediction model, the prosody feature information comprising prosody features corresponding to a plurality of predetermined prosody dimensions;
wherein the prosody prediction model comprises a feature extraction network and a plurality of feature prediction networks, the feature extraction network being configured to extract linguistic information of the target text, the plurality of feature prediction networks each connected to the feature extraction network and being corresponding to the predetermined prosody dimensions, respectively, and each of the feature prediction networks being configured to predict, based on the linguistic information extracted by the feature extraction network, a prosody feature corresponding to a predetermined prosody dimension.

In a second aspect, the present disclosure provides an apparatus for prosody prediction. The apparatus comprises:
a first acquiring module configured to obtain a target text to be processed;
a first determination module configured to determine prosody feature information of the target text based on the target text and a pre-trained prosody prediction model, the prosody feature information comprising prosody features corresponding to a plurality of predetermined prosody dimensions;
wherein the prosody prediction model comprises a feature extraction network and a plurality of feature prediction networks, the feature extraction network being configured to extract linguistic information of the target text, the plurality of feature prediction networks each connected to the feature extraction network and being corresponding to the predetermined prosody dimensions, respectively, and each of the feature prediction networks being configured to predict, based on the linguistic information extracted by the feature extraction network, a prosody feature corresponding to a predetermined prosody dimension.

In a third aspect, the present disclosure provides a computer readable storage medium having a computer program stored thereon, the computer program, when executed by a processor, implementing steps of the method according to the first aspect of the present disclosure.

In a fourth aspect, the present disclosure provides an electronic device. The electronic device comprises:
a storage device having at least one computer program stored thereon;
at least one processing unit configured to execute the at least one computer program in the storage device, implementing the method according to the first aspect of the present disclosure.

In a fifth aspect, the present disclosure provides a computer program product having a computer program stored thereon which, when executed by at least one processing unit, implements the method according to the first aspect of the present disclosure.

According to a sixth aspect, a computer program is provided, which when executed by at least one processing unit, implements the method according to the first aspect of the present disclosure.

Additional features and advantages of the disclosure will be set forth in the detailed description which follows.

### BRIEF DESCRIPTION OF THE DRAWINGS

The above and other features, advantages, and aspects of various embodiments of the present disclosure will become more apparent with reference to the following detailed description taken in conjunction with the accompanying drawings. Throughout the drawings, the same or like reference numerals denote the same or like elements, it being understood that the drawings are illustrative and that elements and elements may not be drawn to scale. In the drawings:

FIG. 1 is a flowchart of a method for prosody prediction according to embodiments of the present disclosure;

FIG. 2 is an example flowchart of steps of determining prosody feature information of a target text in a method for prosody prediction according to the present disclosure;

FIG. 3 is a block diagram of an apparatus for prosody prediction provided according to embodiments of the present disclosure;

FIG. 4 shows a schematic diagram of an electronic device suitable for implementing embodiments of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as being limited to the embodiments set forth herein, but rather these embodiments are provided for a thorough and complete understanding of the present disclosure. It should be understood that the drawings and embodiments of the present disclosure are only for illustrative purposes and are not intended to limit the scope of the present disclosure.

It should be understood that the steps recorded in the method embodiments of the present disclosure may be executed in different orders, and/or executed in parallel. Furthermore, method embodiments may include additional steps and/or omit the steps illustrated performing. The scope of the present disclosure is not limited in this respect.

The term “comprising,” and variations thereof, as used herein, is inclusive, i.e., “including but not limited to.” The term “based on” is “based at least in part on”. The term “one embodiment” means “at least one embodiment”; the term “another embodiment” means “at least one further embodiment”; The term “some embodiments” means “at least some embodiments”. Relevant definitions of other terms will be given in the following description.

It should be noted that, the “first’, “second’, and other concepts mentioned in the present disclosure are only used to distinguish different apparatuses, modules, or units, but are not used to limit the sequence or dependency of functions performed by these apparatuses, modules, or units.

It should be noted that the modifications of “a” and “a plurality” mentioned in the present disclosure are illustrative rather than restrictive, and those skilled in the art should understand that they should be understood as “one or more” unless the context clearly indicates otherwise.

The names of messages or information interacted between a plurality of devices in the embodiments of the present disclosure are only for illustrative purposes, and are not intended to limit the scope of these messages or information.

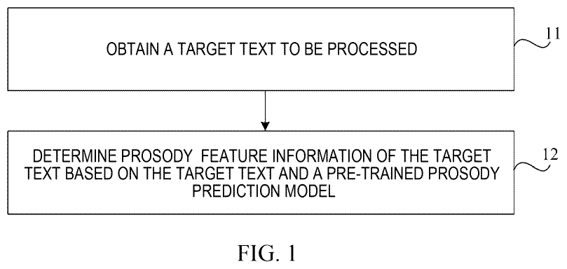

FIG. 1 is a flowchart of a method for prosody prediction according to embodiments of the present disclosure. As shown in FIG. 1, the method provided in the present disclosure may comprise step 11 and step 12.

At step 11, a target text to be processed is obtained.

In the present disclosure, the target text to be processed may be a text corresponding to any language, e. g., Chinese text, English text, etc.

At step 12, prosody feature information of the target text is determined based on the target text and a pre-trained prosody prediction model.

The prosody feature information may include prosody features corresponding to a plurality of predetermined prosody dimensions. As an example, the predetermined prosody dimensions may include, but are not limited to, at least one of a break index, a pitch stress, a phrase stress, and a boundary tone. The break index corresponds to a tempo or pause of the synthesized speech, the pitch stress corresponds to a focus or emphasis of the synthesized speech, and a phrase stress and boundary tone correspond to a tone of the synthesized speech. The method expects to obtain a suitable reasonable prosody feature from semantic information and a grammatical structure of a text.

The prosody prediction model may include a feature extraction network and a plurality of feature prediction networks. The feature extraction network is configured to extract linguistic information of the target text. The linguistic information of the target text may be understood as semantic information and a grammatical structure of the target text. A plurality of feature prediction networks each are connected to feature extraction networks, respectively, and the plurality of feature prediction networks each correspond to a predetermined prosody dimension. Each of feature prediction networks is configured to predict, based on the linguistic information extracted by the feature extraction network. For example, if the predetermined prosody dimension includes pitch stress, phrase stress, and boundary tone, the prosody prediction model may include three feature prediction networks, which are a feature prediction network corresponding to pitch stress, a feature prediction network corresponding to phrase stress and a feature prediction network corresponding to boundary tone. Furthermore, a feature prediction network corresponding to the pitch stress is configured to predict a prosody feature of a predetermined prosody dimension. The feature prediction network corresponding to phrase stress is configured to predict a prosody feature of the predetermined prosody dimension of the phrase stress, The feature prediction network corresponding to the boundary tone is configured to predict the prosody feature of the predetermined prosody dimension of the boundary tone.

Through the above technical solution, a target text to be processed is obtained, and the prosody feature information of the target text is determined based on the target text and the pre-trained prosody prediction model, wherein the prosody feature information comprises prosody features corresponding to a plurality of predetermined prosody dimensions. The prosody prediction model includes a feature extraction network and a plurality of feature prediction networks. The feature extraction network is configured to extract linguistic information of the target text. The plurality of feature prediction networks each are connected to feature extraction networks, respectively. The plurality of feature prediction networks each correspond to a predetermined prosody dimension. Each of feature prediction network is configured to predict, based on the linguistic information extracted by the feature extraction network, a prosody feature corresponding to a predetermined prosody dimension. That is to say, in the prosody prediction model, a feature extraction network capable of extracting high-precision linguistic information is introduced, and a plurality of feature prediction networks include a plurality of prosody dimensions, so as to obtain a required prosody prediction model by multi-task learning, thereby implementing prosody prediction. Thus, for a given text, a high-precision linguistic feature may be extracted through a feature extraction network, and is configured to predict prosody of a feature prediction network, so that a more suitable prosody feature can be obtained, and proper rhythm, emphasis and tone features are provided for the text, thereby facilitating subsequent synthesis of a speech which is more natural and conforms to human hearing based on the prosody feature.

In order to make persons skilled in the art understand the speech synthesis method provided in the present disclosure more clearly, the above steps will be illustrated in detail below.

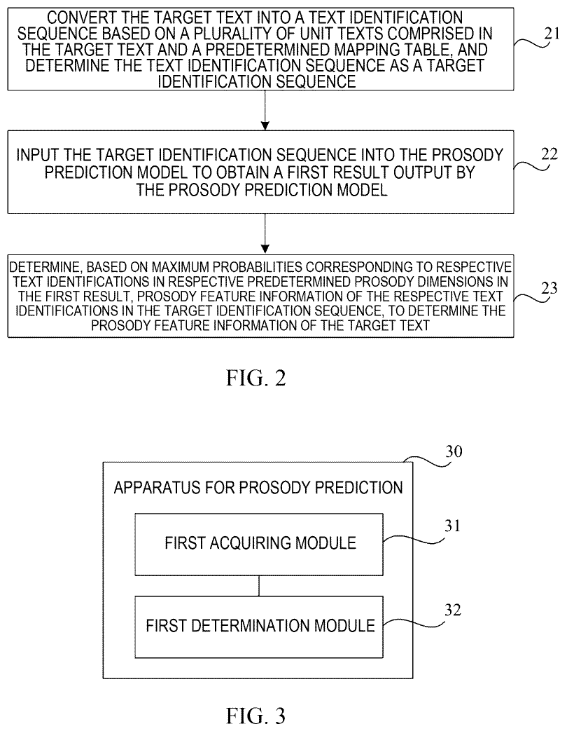

In a possible implementation, step 12 may include step 21 to step 23, as shown in FIG. 2.

At step 21, the target text is converted into a text identification sequence based on a plurality of unit texts comprised in the target text and a predetermined mapping table, and the text identification sequence is determined as a target identification sequence.

The predetermined mapping table indicates a correlation between unit texts and text identifications. The predetermined mapping table may be understood as a word table for providing a mapping correlation between unit texts and text identifications. A text identification may be an ID, and a unit text may be set according to actual requirements. For example, if the target text is a Chinese text, the unit text may be a single text; and if the target text is an English text, the unit text may be content that is split from one English word.

Thus, according to a position of each unit text comprised in the target text, corresponding text identifications are determined according to a predetermined mapping table, respectively, so as to form a target identification sequence corresponding to the target text.

At step 22, the target identification sequence is input into the prosody prediction model to obtain a first result output by the prosody prediction model.

The first result indicates respective probabilities of respective text identifications in the target identification sequence belonging to respective prosody categories in respective predetermined prosody dimensions. Each predetermined prosody dimension may include a plurality of prosody categories, and a prosody category included in each predetermined prosody dimension may be determined according to a category of the prosody feature included in the predetermined prosody dimension. For example, for a predetermined prosody dimension of pitch stress, since the pitch stress may include prosody features of high pitch, low pitch, rising pitch, low rise pitch, and high drop pitch, the predetermined prosody dimension of pitch stress may include five prosody categories, which are high pitch, low pitch, rising pitch, low rise pitch, and high drop pitch, respectively.

As an example, the prosody prediction model may be obtained by:
obtaining a plurality of training datasets;
inputting a target training identification sequence in the training identification sequence into the prosody prediction model in a current round of training to obtain a second result output by the prosody prediction model in the current round of training;
in response to a training stopping condition being satisfied, determining a prosody prediction model in the current round of training as a trained prosody prediction model;
in response to the training stopping condition being dissatisfied, determining a target loss value of the current round of training, updating a parameter of the prosody prediction model in the current round of training using the target loss value, and determining the updated prosody prediction model for use in a next round of training until the training stopping condition is satisfied.

Each training dataset comprises a training identification sequence and prosody label information corresponding to a training text, the training identification sequence is obtained by converting the training text via the predetermined mapping table, and the prosody label information comprises a prosody feature corresponding to a predetermined prosody dimension.

At the start of training, the prosody prediction model may be initialized, i.e., the model structure and parameters within the model are initialized. In the present disclosure, a feature extraction network in a prosody prediction model may be determined first, and after the feature extraction network is determined, a feature prediction network is further added for each predetermined prosody dimension.

The feature extraction network in the prosody prediction model may be obtained based on the ELECTRA model. Since the ELECTRA model is a self-supervised language expression model, based on its own features, the present disclosure may be used as a depth model for prosody feature prediction, and is beneficial to extracting the grammatical structure and semantic information of text, i.e., linguistic information. The ELECTRA model training process obtains its capabilities by distinguishing true input data from data generated by the neural network. The ELECTRA model is trained in a way similar to that of a generative purpose network discriminator. Usually, output content of the last layer of the ELECTRA model include the embedding informing with linguistic information. For example, the existing ELECTRA model can be obtained directly, and is determined as the feature extraction network in the prosody prediction model. For another example, on the basis of obtaining an existing ELECTRA model, unsupervised training may be performed on the ELECTRA model based on an existing text, and after the training is completed, a network is extracted as a feature in a prosody prediction model.

After the feature extraction network is determined, parameters thereof are fixed, and for each predetermined prosody dimension, a feature prediction network is added in a prosody prediction model. The feature prediction network may select a shallow layer network, for example, a convolution layer and a fully-connected layer, and output a posterior probability of each prosody category of the feature prediction network through a softmax layer. Initially, the parameters of the added feature prediction network may be initialized randomly.

After initializing of the prosody prediction model is completed, the training process may be started.

In one training process, a target training identification sequence (namely, input data of the current round training) may be input into a prosody prediction model in a current round training to obtain a second result output by the prosody prediction model in the current round of training. The second result indicating respective probabilities of each text identification in the target training identification sequence belonging to prosody categories in the respective predetermined prosody dimensions.

In this case, it is determined whether the prosody prediction model in the current round of training satisfies a training stopping condition. The training stopping condition may be predetermined according to an actual demand of training. As an example, the training stopping condition may be that the number of training times reaches a predetermined number, and for another example, the training stopping condition may be that a training duration reaches a predetermined duration. For another example, the training stopping condition may be that a loss value of the current round of training is less than a predetermined loss value.

If the prosody prediction model in the current round of training satisfies the training stopping condition, the prosody prediction model in the current round of training may be determined to be a trained prosody prediction model.

If the prosody prediction model in the current round of training does not satisfy the training stopping condition, it indicates that the prosody prediction model used in the current round of training still does not satisfy the requirements, and training still needs to be continued. Therefore, the loss value of the current round of training may be determined as a target loss value. The parameters of the prosody prediction model in the current round of training are updated by using the target loss value, and the updated prosody prediction model is used for the next round of training until the training stopping condition is satisfied.

The target loss value is determined based on the prosody label information corresponding to the target training identification sequence and the second result.

A second result may include output content of each of the feature prediction networks in the prosody prediction model in the current round of training. In a possible implementation, a step of determining the target loss value of the current training may include the following steps:
performing respective loss value calculations on respective output contents based on the prosody label information corresponding to the target training identification sequence, to obtain respective loss values corresponding to the respective feature prediction networks;
performing weighted summation on the respective loss values corresponding to the respective feature prediction networks based on calculation weights of the respective feature prediction networks, to obtain the target loss value.

That is to say, a loss value calculation is performed based on the output content of each feature prediction network and the expected output content (prosody label information) of the training data. Based on the loss values, a total loss value (namely, a target loss value) in the current round of training is obtained, and is used for updating a model. The loss value may be calculated by using the cross entropy loss function.

In a possible implementation, respective loss values corresponding to respective feature prediction networks may be obtained in the following manner, i.e.:
determining the respective feature prediction networks as respective target feature prediction network, and performing the following operations:
determining, based on the plurality of training datasets, respective calculation weights corresponding to prosody categories comprised in a target prosody dimension;
determining a loss value corresponding to a target feature prediction network based on the prosody label information corresponding to the target training identification sequence, the output content of the target feature prediction network and the respective calculation weights corresponding to the respective prosody categories of the target prosody dimensions.

The target prosody dimension being a predetermined prosody dimension corresponding to a target feature prediction network, and the more times a prosody category appears in the plurality of training datasets, the smaller a calculation weight corresponding to the prosody category is.

That is to say, for a prediction task of each predetermined prosody dimension, different calculation weights are set for various categories of the predetermined prosody dimension, a smaller weight is assigned to a prosody category with a large amount of training data, and a larger weight is assigned to a prosody category with a small amount of training data, so that a target loss value is in a relatively reasonable range, which is beneficial for balancing the output of various prosody categories.

In another possible embodiment, different computational weights may be assigned to different feature prediction networks. The computation weight corresponding to the feature prediction network is inversely related to the loss value corresponding to the feature prediction network. That is, the larger the loss value corresponding to the feature prediction network, the smaller the calculation weight corresponding to the feature prediction network, and the smaller the loss value corresponding to the feature prediction network, the larger the calculation weight corresponding to the feature prediction network. In this way, the loss function can be in a reasonable range, which helps balance the output of the feature prediction network of each predetermined prosody dimension.

At step 23, based on maximum probabilities corresponding to respective text identifications in respective predetermined prosody dimensions in the first result, prosody feature information of the respective text identifications in the target identification sequence is determined, to determine the prosody feature information of the target text.

In one possible embodiment, the predetermined prosody dimension may include pitch stress, phrase weight, and boundary tone, not including a break index. Accordingly, step 23 may include the following steps:
for each text identification in the target identification sequence, determining pitch stresses, phrase stresses, and boundary tones corresponding to the prosody feature information of the text identification based on the maximum probabilities corresponding to the text identification in the respective predetermined prosody dimensions, and determining prosody feature information of a break index corresponding to the text identification based on the phrase stresses and the boundary tones corresponding to the prosody feature information of the text identification, and a predetermined correlation between respective phrase stresses, boundary tones and break indexes.

That is to say, in the training process, only the predetermined prosody dimensions corresponding to pitch stress, phrase stress, or boundary tone is trained. The predetermined prosody dimension corresponding to the break index is not trained. Thus, the target identification sequence is input into a trained prosody prediction model, and prosody feature information of the target identification sequence corresponding to pitch stress, phrase stress, or boundary tone can be predicted. Meanwhile, since there is an inherent correspondence relationship (mapping relationship) between the phrase stress, boundary tone, and break index, the prosody feature information corresponding to the break index can be deduced directly according to the phrase stress and boundary tone predicted by the prosody prediction model.

For example, if the predicted phrase stress and boundary tone are both 0, it indicates that no phrase stress and boundary tone are provided at this location, which means that the break index at this location is 1, and it is a boundary of a prosody word; if the predicted phrase stress is not 0 and the boundary tone is 0, it means that only the phrase stress is provided and no boundary tone is provided, which means that the break index here is 3 and is a small boundary of a prosodic phrase; If neither the predicted phrase stress nor the boundary tone are 0, it indicates that the phrase stress and the boundary tone are provided, which means that the break index here is 4, which is a large boundary of the prosody phrase.

Through the above-described method, a prosody prediction model is used to predict prosody feature information corresponding to pitch stress, phrase stress and boundary tone. Further prosody feature information corresponding to the break index is deduced based on the inherent relationship between the phrase stress, boundary tone, and simple index. The training of the prosody prediction task, i.e. the break index, in the process of model training is omitted, and the prosody prediction model can be effectively simplified, improving the training speed of a model.

In another possible implementation, the predetermined prosody dimensions include break index, pitch stress, phrase stress and boundary tone. Accordingly, step 23 may comprise the following steps:

for each text identification in the target identification sequence, determining break indexes, pitch stresses, phrase stresses and boundary tones corresponding to the prosody feature information of the text identification based on the maximum probabilities corresponding to the text identification in the respective predetermined prosody dimensions.

That is to say, in the training process, the prosody dimensions, such as the break index, the pitch stress, the phrase stress, and the boundary tone, are predicted, so that the prosody feature information corresponding to the break index, the pitch stress, the phrase stress, and the boundary tone can be obtained directly through the prosody prediction model without additionally performing other reasoning operations, thereby achieving high inference efficiency.

FIG. 3 is a block diagram of an apparatus for prosody prediction according to embodiments of the present disclosure. As shown in FIG. 3, the apparatus 30 comprises:
a first acquiring module 31, configured to obtain a target text to be processed;
a first determination module 32, configured to determine prosody feature information of the target text based on the target text and a pre-trained prosody prediction model, the prosody feature information comprising prosody features corresponding to a plurality of predetermined prosody dimensions;
wherein the prosody prediction model comprises a feature extraction network and a plurality of feature prediction networks, the feature extraction network being configured to extract linguistic information of the target text, the plurality of feature prediction networks each connected to the feature extraction network and being corresponding to the predetermined prosody dimensions, respectively, and each of the feature prediction networks being configured to predict, based on the linguistic information extracted by the feature extraction network, a prosody feature corresponding to a predetermined prosody dimension.

Optionally, each predetermined prosody dimension includes a plurality of prosody categories;
the first determination module 32 includes:
a conversion submodule configured to convert the target text into a text identification sequence based on a plurality of unit texts comprised in the target text and a predetermined mapping table, and determine the text identification sequence as a target identification sequence, wherein the predetermined mapping table indicates a correlation between unit texts and text identifications;
a processing submodule configured to input the target identification sequence into the prosody prediction model to obtain a first result output by the prosody prediction model, the first result indicating respective probabilities of respective text identifications in the target identification sequence belonging to respective prosody categories in respective predetermined prosody dimensions;
a first determining submodule configured to determine, based on maximum probabilities corresponding to respective text identifications in respective predetermined prosody dimensions in the first result, prosody feature information of the respective text identifications in the target identification sequence, to determine the prosody feature information of the target text.

Optionally, the prosody prediction model is obtained by the following modules:
a second acquisition module configured to obtain a plurality of training datasets, wherein each training dataset comprises a training identification sequence and prosody label information corresponding to a training text, the training identification sequence is obtained by converting the training text via the predetermined mapping table, and the prosody label information comprises a prosody feature corresponding to a predetermined prosody dimension;
a first processing module configured to input a target training identification sequence in the training identification sequence into the prosody prediction model in a current round of training to obtain a second result output by the prosody prediction model in the current round of training, the second result indicating respective probabilities of each text identification in the target training identification sequence belonging to prosody categories in the respective predetermined prosody dimensions;
a second determining module configured to determine, in response to a training stopping condition being satisfied, a prosody prediction model in the current round of training as a trained prosody prediction model;
a second processing module configured to update, in response to the training stopping condition being dissatisfied, determining a target loss value of the current round of training, a parameter of the prosody prediction model in the current round of training using the target loss value, and determine the updated prosody prediction model for use in a next round of training until the training stopping condition is satisfied, wherein the target loss value is determined based on the prosody label information corresponding to the target training identification sequence and the second result.

Optionally, the second result comprises output content of each of the feature prediction networks in the prosody prediction model in the current round of training;
the second processing module comprises:
a first calculating submodule configured to perform respective loss value calculations on respective output contents based on the prosody label information corresponding to the target training identification sequence, to obtain respective loss values corresponding to the respective feature prediction networks;
and a second calculation sub-module configured to perform weighted summation on the respective loss values corresponding to the respective feature prediction networks based on calculation weights of the respective feature prediction networks, to obtain the target loss value.

Optionally, the first calculating submodule is configured to determine the respective feature prediction networks as respective target feature prediction network, and perform the following operations:
determining, based on the plurality of training datasets, respective calculation weights corresponding to prosody categories comprised in a target prosody dimension, the target prosody dimension being a predetermined prosody dimension corresponding to a target feature prediction network, and the more times a prosody category appears in the plurality of training datasets, the smaller a calculation weight corresponding to the prosody category is;
determining a loss value corresponding to a target feature prediction network based on the prosody label information corresponding to the target training identification sequence, the output content of the target feature prediction network and the respective calculation weights corresponding to the respective prosody categories of the target prosody dimensions.

Optionally, a calculation weight corresponding to a feature prediction network is inversely related to a loss value corresponding to the feature prediction network.

Optionally, the predetermined prosody dimension comprises a pitch stress, a phrase stress, and a boundary tone;
the first determining submodule is configured to:
for each text identification in the target identification sequence, determine pitch stresses, phrase stresses, and boundary tones corresponding to the prosody feature information of the text identification based on the maximum probabilities corresponding to the text identification in the respective predetermined prosody dimensions, and determine prosody feature information of a break index corresponding to the text identification based on the phrase stresses and the boundary tones corresponding to the prosody feature information of the text identification, and a predetermined correlation between respective phrase stresses, boundary tones and break indexes.

Optionally, the predetermined prosody dimension comprises a break index, a pitch stress, a phrase stress, and a boundary tone;
the first determining submodule is configured to:
for each text identification in the target identification sequence, determine break indexes, pitch stresses, phrase stresses and boundary tones corresponding to the prosody feature information of the text identification based on the maximum probabilities corresponding to the text identification in the respective predetermined prosody dimensions.

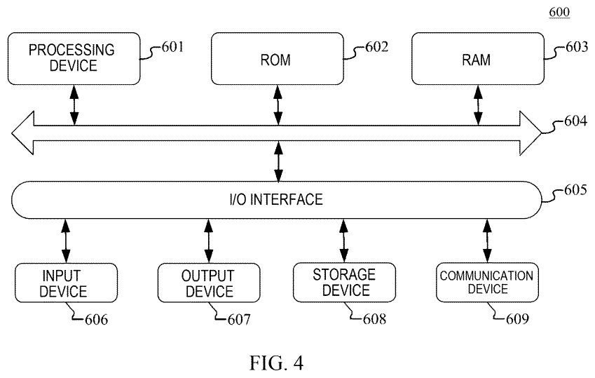

The communication device 609 can allow the electronic device 600 to wirelessly or wired communicate with other devices to exchange data. While FIG. 4 illustrates an electronic device 600 with a variety of devices, it should be understood that it is not required that all of the illustrated devices be implemented or provided. More or fewer devices may alternatively be implemented or provided.

In particular, the processes described above with reference to the flowcharts can be implemented as computer software programs in accordance with embodiments of the present disclosure. For example, embodiments of the disclosure include a computer program product comprising a computer program carried on a non-transitory computer-readable medium, the computer program comprising program code for performing the method as shown in the flowchart. In such an embodiment, the computer program may be downloaded and installed from the network via the communication device 609, or installed from the storage 608, or installed from the ROM 602. When the computer program is executed by the processing device 601, the described functions defined in the method according to the embodiment of the present disclosure are executed.

Embodiments of the present disclosure further provide a computer program. The computer program is stored in a readable storage medium. One or more processors of an electronic device may read the computer program from the readable storage medium. The one or more processors execute the computer program, so that the electronic device executes the solution provided by any one of the above embodiments.

It should be noted that the computer readable medium in the present disclosure may be a computer readable signal medium or a computer readable storage medium, or any combination thereof. A computer-readable storage medium may be, for example, but not limited to, an electronic, magnetic, optical, electromagnetic, infrared, or semiconductor system, apparatus, or device, or any suitable combination of the foregoing. More specific examples of the computer readable storage medium may include, but are not limited to, an electrical connection having one or more wires, a portable computer diskette, a hard disk, a random access memory (RAM), a read-only memory (ROM), an erasable programmable read-only memory (Erasable Programmable Read-Only Memory), an EPROM or flash memory), an optical fiber, a portable compact disc read only memory (CD-ROM), an optical storage device, a magnetic storage device, or any suitable combination of the foregoing. In the present disclosure, a computer readable storage medium may be any tangible medium that can contain or store a program for use by or in connection with an instruction execution system, apparatus, or device. While in the present disclosure, a computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may also be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including, but not limited to, wireline, optical fiber cable, RF (Radio Frequency), etc., or any suitable combination of the foregoing.

In some embodiments, clients, servers can communicate using any currently known or future developed network protocol, such as the Hypertext Transfer Brief of the case (HTTP), and can be interconnected with digital data communication (e. g., a communication network) in any form or medium. Examples of communication networks include a local area network (LAN), a wide area network (WAN), an Internet (e. g., the Internet), and an ad hoc peer-to-peer network (e. g., an ad hoc peer-to-peer network), as well as any currently known or future developed network.

The computer readable medium may be included in the electronic device, or may exist separately and not be installed in the electronic device.

The computer readable medium has one or more programs. When the one or more programs are executed by the electronic device, the electronic device is enabled to: obtain a target text to be processed; and determine prosody feature information of the target text based on the target text and a pre-trained prosody prediction model, the prosody feature information comprising prosody features corresponding to a plurality of predetermined prosody dimensions; wherein the prosody prediction model comprises a feature extraction network and a plurality of feature prediction networks, the feature extraction network being configured to extract linguistic information of the target text, the plurality of feature prediction networks each connected to the feature extraction network and being corresponding to the predetermined prosody dimensions, respectively, and each of the feature prediction networks being configured to predict, based on the linguistic information extracted by the feature extraction network, a prosody feature corresponding to a predetermined prosody dimension.

Computer program code for carrying out operations for aspects of the present disclosure may be written in any combination of one or more programming languages, including, but not limited to, an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The modules involved in the embodiments of the present disclosure may be implemented by software or by hardware. The name of the module does not constitute a limitation to the module itself in a certain case. For example, the first obtaining module may also be described as ‘a module for obtaining the target text to be processed’.

The functions described herein above may be performed, at least in part, by one or more hardware logic components. For example, exemplary types of hardware logic components that can be used include, without limitation, Field-Programmable Gate Arrays (FPGAs), Application Specific Integrated Circuit (ASICs), Application Specific Standard Products (ASSPs), System-on-a-chip systems (SOCs), Complex Programmable Logic Devices (CPLDs), etc.

In the context of this disclosure, a machine-readable medium may be tangible media that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media would include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing.

According to one or more embodiments of the present disclosure, a method for prosody prediction is provided. The method comprises:
obtaining a target text to be processed; and
determining prosody feature information of the target text based on the target text and a pre-trained prosody prediction model, the prosody feature information comprising prosody features corresponding to a plurality of predetermined prosody dimensions;
wherein the prosody prediction model comprises a feature extraction network and a plurality of feature prediction networks, the feature extraction network being configured to extract linguistic information of the target text, the plurality of feature prediction networks each connected to the feature extraction network and being corresponding to the predetermined prosody dimensions, respectively, and each of the feature prediction networks being configured to predict, based on the linguistic information extracted by the feature extraction network, a prosody feature corresponding to a predetermined prosody dimension

According to one or more embodiments of the present disclosure, a method for prosody prediction is provided, wherein each predetermined prosody dimension comprises a plurality of prosody categories;
determining prosody feature information of the target text based on the target text and the pre-trained prosody prediction model comprises:
converting the target text into a text identification sequence based on a plurality of unit texts comprised in the target text and a predetermined mapping table, and determining the text identification sequence as a target identification sequence, wherein the predetermined mapping table indicates a correlation between unit texts and text identifications;
inputting the target identification sequence into the prosody prediction model to obtain a first result output by the prosody prediction model, the first result indicating respective probabilities of respective text identifications in the target identification sequence belonging to respective prosody categories in respective predetermined prosody dimensions;
determining, based on maximum probabilities corresponding to respective text identifications in respective predetermined prosody dimensions in the first result, prosody feature information of the respective text identifications in the target identification sequence, to determine the prosody feature information of the target text.

According to one or more embodiments of the present disclosure, a method for prosody prediction is provided, wherein the prosody prediction model is obtained by:
obtaining a plurality of training datasets, wherein each training dataset comprises a training identification sequence and prosody label information corresponding to a training text, the training identification sequence is obtained by converting the training text via the predetermined mapping table, and the prosody label information comprises a prosody feature corresponding to a predetermined prosody dimension;
inputting a target training identification sequence in the training identification sequence into the prosody prediction model in a current round of training to obtain a second result output by the prosody prediction model in the current round of training, the second result indicating respective probabilities of each text identification in the target training identification sequence belonging to prosody categories in the respective predetermined prosody dimensions;
in response to a training stopping condition being satisfied, determining a prosody prediction model in the current round of training as a trained prosody prediction model;
in response to the training stopping condition being dissatisfied, determining a target loss value of the current round of training, updating a parameter of the prosody prediction model in the current round of training using the target loss value, and determining the updated prosody prediction model for use in a next round of training until the training stopping condition is satisfied, wherein the target loss value is determined based on the prosody label information corresponding to the target training identification sequence and the second result.

According to one or more embodiments of the present disclosure, a method for prosody prediction is provided, wherein the second result comprises output content of each of the feature prediction networks in the prosody prediction model in the current round of training;
determining the target lost value of the current training comprises:
performing respective loss value calculations on respective output contents based on the prosody label information corresponding to the target training identification sequence, to obtain respective loss values corresponding to the respective feature prediction networks;
performing weighted summation on the respective loss values corresponding to the respective feature prediction networks based on calculation weights of the respective feature prediction networks, to obtain the target loss value.

According to one or more embodiments of the present disclosure, a method for prosody prediction is provided. When performing respective loss value calculations on respective output contents based on the prosody label information corresponding to the target training identification sequence, to obtain respective loss values corresponding to respective feature prediction networks, the method comprises:
determining the respective feature prediction networks as respective target feature prediction network, and performing the following:
determining, based on the plurality of training datasets, respective calculation weights corresponding to prosody categories comprised in a target prosody dimension, the target prosody dimension being a predetermined prosody dimension corresponding to a target feature prediction network, and the more times a prosody category appears in the plurality of training datasets, the smaller a calculation weight corresponding to the prosody category is;
determining a loss value corresponding to a target feature prediction network based on the prosody label information corresponding to the target training identification sequence, the output content of the target feature prediction network and the respective calculation weights corresponding to the respective prosody categories of the target prosody dimensions.

According to one or more embodiments of the present disclosure, a method for prosody prediction is provided. A calculation weight corresponding to a feature prediction network is inversely related to a loss value corresponding to the feature prediction network.

According to one or more embodiments of the present disclosure, a method for prosody prediction is provided. The predetermined prosody dimension comprises a pitch stress, a phrase stress, and a boundary tone;
determining, based on the maximum probabilities corresponding to respective text identifications in respective predetermined prosody dimensions in the first result, prosody feature information of the respective text identifications in the target identification sequence, to determine the prosody feature information of the target text comprises:
for each text identification in the target identification sequence, determining pitch stresses, phrase stresses, and boundary tones corresponding to the prosody feature information of the text identification based on the maximum probabilities corresponding to the text identification in the respective predetermined prosody dimensions, and determining prosody feature information of a break index corresponding to the text identification based on the phrase stresses and the boundary tones corresponding to the prosody feature information of the text identification, and a predetermined correlation between respective phrase stresses, boundary tones and break indexes.

According to one or more embodiments of the present disclosure, a method for prosody prediction is provided. A predetermined prosody dimension comprises a break index, a pitch stress, a phrase stress, and a boundary tone;
determining, based on the maximum probabilities corresponding to respective text identifications in respective predetermined prosody dimensions in the first result, prosody feature information of the respective text identifications in the target identification sequence, to determine the prosody feature information of the target text comprises:
for each text identification in the target identification sequence, determining break indexes, pitch stresses, phrase stresses and boundary tones corresponding to the prosody feature information of the text identification based on the maximum probabilities corresponding to the text identification in the respective predetermined prosody dimensions.

According to one or more embodiments of the present disclosure, an apparatus for prosody prediction is provided. The apparatus comprises:
a first acquiring module configured to obtain a target text to be processed;
a first determination module configured to determine prosody feature information of the target text based on the target text and a pre-trained prosody prediction model, the prosody feature information comprising prosody features corresponding to a plurality of predetermined prosody dimensions;
wherein the prosody prediction model comprises a feature extraction network and a plurality of feature prediction networks, the feature extraction network being configured to extract linguistic information of the target text, the plurality of feature prediction networks each connected to the feature extraction network and being corresponding to the predetermined prosody dimensions, respectively, and each of the feature prediction networks being configured to predict, based on the linguistic information extracted by the feature extraction network, a prosody feature corresponding to a predetermined prosody dimension.

According to one or more embodiments of the present disclosure, a computer readable medium having a computer program is provided. The computer program, when executed by a processor, implements steps of the method for prosody prediction provided by any embodiment of the present disclosure.

According to one or more embodiments of the present disclosure, an electronic device is provided. The electronic device comprises:
a storage device having at least one computer program stored thereon;
at least one processing unit configured to execute the at least one computer program in the storage device, implement the steps of the method for prosody prediction according to any embodiment of the present disclosure.

According to one or more embodiments of the present disclosure, a computer program product is provided. The computer program product having a computer program stored thereon which, when executed by at least one processing unit, implements the steps of the method for prosody prediction provided by any embodiment of the present disclosure.

According to one or more embodiments of the present disclosure, a computer program is provided. The computer program, when being executed by a processing device, implements the steps of the method for prosody prediction provided by any embodiment of the present disclosure.

The foregoing description is merely illustrative of the preferred embodiments of the present disclosure and of the technical principles applied thereto, as will be appreciated by those skilled in the art, The disclosure of the present disclosure is not limited to the technical solution formed by the specific combination of the described technical features, At the same time, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution.

In addition, while operations are depicted in a particular order, this should not be understood as requiring that the operations be performed in the particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims. With respect to the apparatus in the foregoing embodiments, the specific manner in which the modules execute the operations has been described in detail in the embodiments of the method, and is not described in detail herein.

1. A method for prosody prediction, the method comprising:
obtaining a target text to be processed; and
determining prosody feature information of the target text based on the target text and a pre-trained prosody prediction model, the prosody feature information comprising prosody features corresponding to a plurality of predetermined prosody dimensions;
wherein the prosody prediction model comprises a feature extraction network and a plurality of feature prediction networks, the feature extraction network being configured to extract linguistic information of the target text, the plurality of feature prediction networks each connected to the feature extraction network and being corresponding to the predetermined prosody dimensions, respectively, and each of the feature prediction networks being configured to predict, based on the linguistic information extracted by the feature extraction network, a prosody feature corresponding to a predetermined prosody dimension.

2. The method of claim 1, wherein each predetermined prosody dimension comprises a plurality of prosody categories;
determining prosody feature information of the target text based on the target text and the pre-trained prosody prediction model comprises:
converting the target text into a text identification sequence based on a plurality of unit texts comprised in the target text and a predetermined mapping table, and determining the text identification sequence as a target identification sequence, wherein the predetermined mapping table indicates a correlation between unit texts and text identifications;
inputting the target identification sequence into the prosody prediction model to obtain a first result output by the prosody prediction model, the first result indicating respective probabilities of respective text identifications in the target identification sequence belonging to respective prosody categories in respective predetermined prosody dimensions; and
determining, based on maximum probabilities corresponding to respective text identifications in respective predetermined prosody dimensions in the first result, prosody feature information of the respective text identifications in the target identification sequence, to determine the prosody feature information of the target text.

3. The method of claim 2, wherein the prosody prediction model is obtained by:
obtaining a plurality of training datasets, wherein each training dataset comprises a training identification sequence and prosody label information corresponding to a training text, the training identification sequence is obtained by converting the training text via the predetermined mapping table, and the prosody label information comprises a prosody feature corresponding to a predetermined prosody dimension;
inputting a target training identification sequence in the training identification sequence into the prosody prediction model in a current round of training to obtain a second result output by the prosody prediction model in the current round of training, the second result indicating respective probabilities of each text identification in the target training identification sequence belonging to prosody categories in the respective predetermined prosody dimensions;
in response to a training stopping condition being satisfied, determining a prosody prediction model in the current round of training as a trained prosody prediction model; and
in response to the training stopping condition being dissatisfied, determining a target loss value of the current round of training, updating a parameter of the prosody prediction model in the current round of training using the target loss value, and determining the updated prosody prediction model for use in a next round of training until the training stopping condition is satisfied, wherein the target loss value is determined based on the prosody label information corresponding to the target training identification sequence and the second result.

4. The method of claim 3, wherein the second result comprises output content of each of the feature prediction networks in the prosody prediction model in the current round of training; and
wherein determining the target lost value of the current training comprises:
performing respective loss value calculations on respective output contents based on the prosody label information corresponding to the target training identification sequence, to obtain respective loss values corresponding to the respective feature prediction networks; and
performing weighted summation on the respective loss values corresponding to the respective feature prediction networks based on calculation weights of the respective feature prediction networks, to obtain the target loss value.

5. The method of claim 4, wherein performing respective loss value calculations on respective output contents based on the prosody label information corresponding to the target training identification sequence, to obtain respective loss values corresponding to respective feature prediction networks comprises:
determining the respective feature prediction networks as respective target feature prediction network, and performing the following:
determining, based on the plurality of training datasets, respective calculation weights corresponding to prosody categories comprised in a target prosody dimension, the target prosody dimension being a predetermined prosody dimension corresponding to a target feature prediction network, and the more times a prosody category appears in the plurality of training datasets, the smaller a calculation weight corresponding to the prosody category is; and
determining a loss value corresponding to a target feature prediction network based on the prosody label information corresponding to the target training identification sequence, the output content of the target feature prediction network and the respective calculation weights corresponding to the respective prosody categories of the target prosody dimensions.

6. The method of claim 4, wherein a calculation weight corresponding to a feature prediction network is inversely related to a loss value corresponding to the feature prediction network.

7. The method of claim 2, wherein the predetermined prosody dimension comprises a pitch stress, a phrase stress, and a boundary tone; and
wherein determining, based on the maximum probabilities corresponding to respective text identifications in respective predetermined prosody dimensions in the first result, prosody feature information of the respective text identifications in the target identification sequence, to determine the prosody feature information of the target text comprises:
for each text identification in the target identification sequence, determining pitch stresses, phrase stresses, and boundary tones corresponding to the prosody feature information of the text identification based on the maximum probabilities corresponding to the text identification in the respective predetermined prosody dimensions, and determining prosody feature information of a break index corresponding to the text identification based on the phrase stresses and the boundary tones corresponding to the prosody feature information of the text identification, and a predetermined correlation between respective phrase stresses, boundary tones and break indexes.

8. The method of claim 2, wherein a predetermined prosody dimension comprises a break index, a pitch stress, a phrase stress, and a boundary tone; and
wherein determining, based on the maximum probabilities corresponding to respective text identifications in respective predetermined prosody dimensions in the first result, prosody feature information of the respective text identifications in the target identification sequence, to determine the prosody feature information of the target text comprises:
for each text identification in the target identification sequence, determining break indexes, pitch stresses, phrase stresses and boundary tones corresponding to the prosody feature information of the text identification based on the maximum probabilities corresponding to the text identification in the respective predetermined prosody dimensions.

9. (canceled)

10. A non-transitory computer readable storage medium having a computer program stored thereon, the computer program, when executed by a processor, implements acts comprising:
obtaining a target text to be processed; and
determining prosody feature information of the target text based on the target text and a pre-trained prosody prediction model, the prosody feature information comprising prosody features corresponding to a plurality of predetermined prosody dimensions;
wherein the prosody prediction model comprises a feature extraction network and a plurality of feature prediction networks, the feature extraction network being configured to extract linguistic information of the target text, the plurality of feature prediction networks each connected to the feature extraction network and being corresponding to the predetermined prosody dimensions, respectively, and each of the feature prediction networks being configured to predict, based on the linguistic information extracted by the feature extraction network, a prosody feature corresponding to a predetermined prosody dimension.

11. An electronic device, comprising:
a storage device having at least one computer program stored thereon;
at least one processing unit configured to execute the at least one computer program in the storage device, implementing acts comprising:
obtaining a target text to be processed; and
determining prosody feature information of the target text based on the target text and a pre-trained prosody prediction model, the prosody feature information comprising prosody features corresponding to a plurality of predetermined prosody dimensions;
wherein the prosody prediction model comprises a feature extraction network and a plurality of feature prediction networks, the feature extraction network being configured to extract linguistic information of the target text, the plurality of feature prediction networks each connected to the feature extraction network and being corresponding to the predetermined prosody dimensions, respectively, and each of the feature prediction networks being configured to predict, based on the linguistic information extracted by the feature extraction network, a prosody feature corresponding to a predetermined prosody dimension.

12. (canceled)

13. (canceled)

14. The non-transitory computer readable storage medium of claim 10, wherein each predetermined prosody dimension comprises a plurality of prosody categories;
determining prosody feature information of the target text based on the target text and the pre-trained prosody prediction model comprises:
converting the target text into a text identification sequence based on a plurality of unit texts comprised in the target text and a predetermined mapping table, and determining the text identification sequence as a target identification sequence, wherein the predetermined mapping table indicates a correlation between unit texts and text identifications;
inputting the target identification sequence into the prosody prediction model to obtain a first result output by the prosody prediction model, the first result indicating respective probabilities of respective text identifications in the target identification sequence belonging to respective prosody categories in respective predetermined prosody dimensions; and
determining, based on maximum probabilities corresponding to respective text identifications in respective predetermined prosody dimensions in the first result, prosody feature information of the respective text identifications in the target identification sequence, to determine the prosody feature information of the target text.

15. The non-transitory computer readable storage medium of claim 14, wherein the prosody prediction model is obtained by:
obtaining a plurality of training datasets, wherein each training dataset comprises a training identification sequence and prosody label information corresponding to a training text, the training identification sequence is obtained by converting the training text via the predetermined mapping table, and the prosody label information comprises a prosody feature corresponding to a predetermined prosody dimension;
inputting a target training identification sequence in the training identification sequence into the prosody prediction model in a current round of training to obtain a second result output by the prosody prediction model in the current round of training, the second result indicating respective probabilities of each text identification in the target training identification sequence belonging to prosody categories in the respective predetermined prosody dimensions;
in response to a training stopping condition being satisfied, determining a prosody prediction model in the current round of training as a trained prosody prediction model;
in response to the training stopping condition being dissatisfied, determining a target loss value of the current round of training, updating a parameter of the prosody prediction model in the current round of training using the target loss value, and determining the updated prosody prediction model for use in a next round of training until the training stopping condition is satisfied, wherein the target loss value is determined based on the prosody label information corresponding to the target training identification sequence and the second result.

16. The non-transitory computer readable storage medium of claim 15, wherein the second result comprises output content of each of the feature prediction networks in the prosody prediction model in the current round of training; and
wherein determining the target lost value of the current training comprises:
performing respective loss value calculations on respective output contents based on the prosody label information corresponding to the target training identification sequence, to obtain respective loss values corresponding to the respective feature prediction networks; and
performing weighted summation on the respective loss values corresponding to the respective feature prediction networks based on calculation weights of the respective feature prediction networks, to obtain the target loss value.

17. The non-transitory computer readable storage medium of claim 16, wherein performing respective loss value calculations on respective output contents based on the prosody label information corresponding to the target training identification sequence, to obtain respective loss values corresponding to respective feature prediction networks comprises:
determining the respective feature prediction networks as respective target feature prediction network, and performing the following:
determining, based on the plurality of training datasets, respective calculation weights corresponding to prosody categories comprised in a target prosody dimension, the target prosody dimension being a predetermined prosody dimension corresponding to a target feature prediction network, and the more times a prosody category appears in the plurality of training datasets, the smaller a calculation weight corresponding to the prosody category is; and
determining a loss value corresponding to a target feature prediction network based on the prosody label information corresponding to the target training identification sequence, the output content of the target feature prediction network and the respective calculation weights corresponding to the respective prosody categories of the target prosody dimensions.

18. The non-transitory computer readable storage medium of claim 16, wherein a calculation weight corresponding to a feature prediction network is inversely related to a loss value corresponding to the feature prediction network.

19. The non-transitory computer readable storage medium of claim 14, wherein the predetermined prosody dimension comprises a pitch stress, a phrase stress, and a boundary tone;
wherein determining, based on the maximum probabilities corresponding to respective text identifications in respective predetermined prosody dimensions in the first result, prosody feature information of the respective text identifications in the target identification sequence, to determine the prosody feature information of the target text comprises:
for each text identification in the target identification sequence, determining pitch stresses, phrase stresses, and boundary tones corresponding to the prosody feature information of the text identification based on the maximum probabilities corresponding to the text identification in the respective predetermined prosody dimensions, and determining prosody feature information of a break index corresponding to the text identification based on the phrase stresses and the boundary tones corresponding to the prosody feature information of the text identification, and a predetermined correlation between respective phrase stresses, boundary tones and break indexes.

20. The non-transitory computer readable storage medium of claim 14, wherein a predetermined prosody dimension comprises a break index, a pitch stress, a phrase stress, and a boundary tone;
wherein determining, based on the maximum probabilities corresponding to respective text identifications in respective predetermined prosody dimensions in the first result, prosody feature information of the respective text identifications in the target identification sequence, to determine the prosody feature information of the target text comprises:
for each text identification in the target identification sequence, determining break indexes, pitch stresses, phrase stresses and boundary tones corresponding to the prosody feature information of the text identification based on the maximum probabilities corresponding to the text identification in the respective predetermined prosody dimensions.

21. The electronic device of claim 11, wherein each predetermined prosody dimension comprises a plurality of prosody categories;
determining prosody feature information of the target text based on the target text and the pre-trained prosody prediction model comprises:
converting the target text into a text identification sequence based on a plurality of unit texts comprised in the target text and a predetermined mapping table, and determining the text identification sequence as a target identification sequence, wherein the predetermined mapping table indicates a correlation between unit texts and text identifications;
inputting the target identification sequence into the prosody prediction model to obtain a first result output by the prosody prediction model, the first result indicating respective probabilities of respective text identifications in the target identification sequence belonging to respective prosody categories in respective predetermined prosody dimensions; and
determining, based on maximum probabilities corresponding to respective text identifications in respective predetermined prosody dimensions in the first result, prosody feature information of the respective text identifications in the target identification sequence, to determine the prosody feature information of the target text.

22. The electronic device of claim 21, wherein the prosody prediction model is obtained by:
obtaining a plurality of training datasets, wherein each training dataset comprises a training identification sequence and prosody label information corresponding to a training text, the training identification sequence is obtained by converting the training text via the predetermined mapping table, and the prosody label information comprises a prosody feature corresponding to a predetermined prosody dimension;
inputting a target training identification sequence in the training identification sequence into the prosody prediction model in a current round of training to obtain a second result output by the prosody prediction model in the current round of training, the second result indicating respective probabilities of each text identification in the target training identification sequence belonging to prosody categories in the respective predetermined prosody dimensions;
in response to a training stopping condition being satisfied, determining a prosody prediction model in the current round of training as a trained prosody prediction model;
in response to the training stopping condition being dissatisfied, determining a target loss value of the current round of training, updating a parameter of the prosody prediction model in the current round of training using the target loss value, and determining the updated prosody prediction model for use in a next round of training until the training stopping condition is satisfied, wherein the target loss value is determined based on the prosody label information corresponding to the target training identification sequence and the second result.

23. The electronic device of claim 22, wherein the second result comprises output content of each of the feature prediction networks in the prosody prediction model in the current round of training; and
wherein determining the target lost value of the current training comprises:
performing respective loss value calculations on respective output contents based on the prosody label information corresponding to the target training identification sequence, to obtain respective loss values corresponding to the respective feature prediction networks; and
performing weighted summation on the respective loss values corresponding to the respective feature prediction networks based on calculation weights of the respective feature prediction networks, to obtain the target loss value.
